(19) United States
(12) Patent Application Publication
(10) Pub. No.: US 2003/0021494 A1
(43) Pub. Date: Jan. 30, 2003

(54) Method and device for producing an image effect

(76) Inventor: James Lu, Taipei (TW)

Correspondence Address: RABIN & BERDO, P.C., Suite 500, 1101 14th Street, N.W., Washington, DC, 20005, US

(21) Appl. No.: 10/082,237

(22) Filed: Feb. 26, 2002

(30) Foreign Application Priority Data
Jul. 25, 2001 (TW) 90118246

(51) Int. Cl. G06K 9/54

(52) U.S. Cl. 382/307

(57) ABSTRACT

A method and device for producing an image effect, applied to an image residing in an image buffer, is used to increase the flexibility of the image effect module. The device includes an image effect module, an access call-back function unit, and a buffer manager. The application program obtains the source image through the access call-back function unit and transfers the source image as well as the access call-back function unit to the image effect module. The image effect module then performs the image effect processing and the image accessing through the collaboration of the access call-back function unit and the buffer manager. After the image effect module returns the destination image to the application program, the application program receives the pixel values of the destination image for display. This image effect module can be commonly shared by different software applications that have their own access call-back function units without further modification.

This application incorporates by reference Taiwanese application Serial No. 90118246, Filed Jul. 25, 2001.

### BACKGROUND OF THE INVENTION

1. Field of the Invention

This invention relates to a method and device for image processing, and more particularly, to a method and device for producing an image effect.

2. Description of Related Art

In computer image processing, a powerful image processing software can load a photograph or draw a picture for further editing and modifications. Particularly, the image processing software combined with an image effect module can produce splendid image effects by performing image effect processes, such as image deformation, magic-light shading, kaleidoscope effect, turning-pages effect, and so on. Such effects can make the work report, company briefing, business document, and website page look excellent and professional.

When image effect is applied on an image, it usually involves in modifying the value of each pixel in the image. For example, the pixel value of 0 can be modified to 255, and the pixel value of 1 can be changed to 254, thus the image effect changes the image from a positive one to negative one.

The image effect module works on the source image passed by the application and returns the resulting image to it. The source image might include a lot of image pixel values and the sequence of pixel values can be various from one to one. Taking the color values of a true color image as an example, the color value of the image pixel can be RGBRGB . . . , BGRBGR . . . , BGRIBGRI . . . or RRR GGG BBB, which has various arrangements of color sequence. Assuming that the application program use the order of RGB sequence for image it process, and if the image effect module only works on the order of BGR sequence, the two sequences of pixel values have different order. This situation will result in an occurrence of error when trying to apply the image effect on the source image buffer passed by the application, thus the expected image effect will not be generated. For resolving this difficulty, a buffer manager is necessary to be employed to reconcile the different sequence order of the pixel values used by the application and image effect.

Please refer to FIG. 1 for the following description of a conventional device for producing an image effect. The application 100 utilizes the buffer manager 130 to retrieve the pixel values of the image from the image buffer 140. After the source image is transferred to the image effect module 120, the image effect module 120 starts to perform the image accessing and the image effect processing. During the image accessing, the image effect module 120 utilizes the buffer manager 130 to get the pixel values of the image from the image buffer 140. Even though the sequences of the image color values, RGB and BGR, are different, the buffer manager 130 can reconcile the sequences of the pixel values before the application program 100 or the image effect module 120 accesses the image buffer 140. The buffer manager 130 therefore prevents incorrect treatment of the image pixels, which can result from the different sequences of the pixel values.

With the help of buffer manager an application can unify the sequence of pixel value arrangements and access interfaces used among all its image effect modules, i.e. the image effect modules depend on the buffer manger to create the buffer with the same kind of sequence order of pixel value arrangement and access interfaces they can work on. For a second application which relies on a different buffer manger to create image buffer, it is possible that the image buffer it creates is in different sequence order of pixel values or different access interfaces from the one used in the first application, once this situation exists, the image effect modules that can work well for the first application will not work for the second application because of the difference in sequence order of pixel values in their image buffers or different access interfaces in manipulating the image buffer. Therefore, the image effect module 120 is no longer to be commonly shared among different application programs. Instead, it needs to rewrite part of the special effect module 120 for image buffers with different sequence order of pixel values or different access interfaces to make it can be employed by different programs. This situation causes inconvenience to maintain the image effect module 120.

### SUMMARY OF THE INVENTION

It is therefore an objective of the present invention to provide a method and device for producing an image effect. To improve the flexibility of the image effect module, and thereby, improve the convenience of maintenance on the image effect module, the invention uses an access call-back function unit provided by the application program to perform the image accessing.

According to the objective of the invention, the invention provides a method for producing an image effect applied by an image effect module by manipulating the way the image effect is applied to the source image to obtain the destination image. The source image is passed to the image effect module by the application, then the image effect module uses the image access interfaces provided by the access call-back function unit to perform the image effect processing. The image accessing is performed using the access call-back unit and comprises the following steps: (1) creating the destination image; (2) getting a plurality of pixel values of the source image and destination image; and (3) setting the pixel values of the source image being applied by image effect module back to the destination image. After all the pixels are processed by the image effect module, the destination image is returned by the image effect module to the application.

In accordance with the foregoing and other objectives of the present invention, the invention provides a device for producing an image effect, applied to an image residing in an image buffer, which is a temporary memory storage for the image, wherein the image has a number of image pixel values. The device comprises the access call-back function unit, the buffer manager, and the image effect module. The access call-back function unit is for accessing the image pixel values while the buffer manager, coupled to the access call-back function unit, determines the access interface to access the image pixel values of the image buffer. In addition, the image effect module receives the image and the access call-back function unit, to perform the image accessing and the calculations on the image pixel values during the image effect processing.

### BRIEF DESCRIPTION OF DRAWINGS

The invention can be more fully understood from the following detailed description of the preferred embodiments, with reference made to the accompanying drawings, wherein:

FIG. 1 is a block diagram illustrating a conventional device for producing an image effect;

FIG. 2 is a block diagram of a device for producing an image effect according to a preferred embodiment of the present invention;

FIG. 3 is a block diagram of a device for producing an image effect, commonly shared by two different application programs, according to a preferred embodiment of the present invention;

FIG. 4 is a schematic flowchart illustrating the method for producing an image effect, according to a preferred embodiment of the present invention; and

FIG. 5 is a schematic flowchart illustrating the procedure of image accessing using the access call-back function unit according to a preferred embodiment of the present invention.

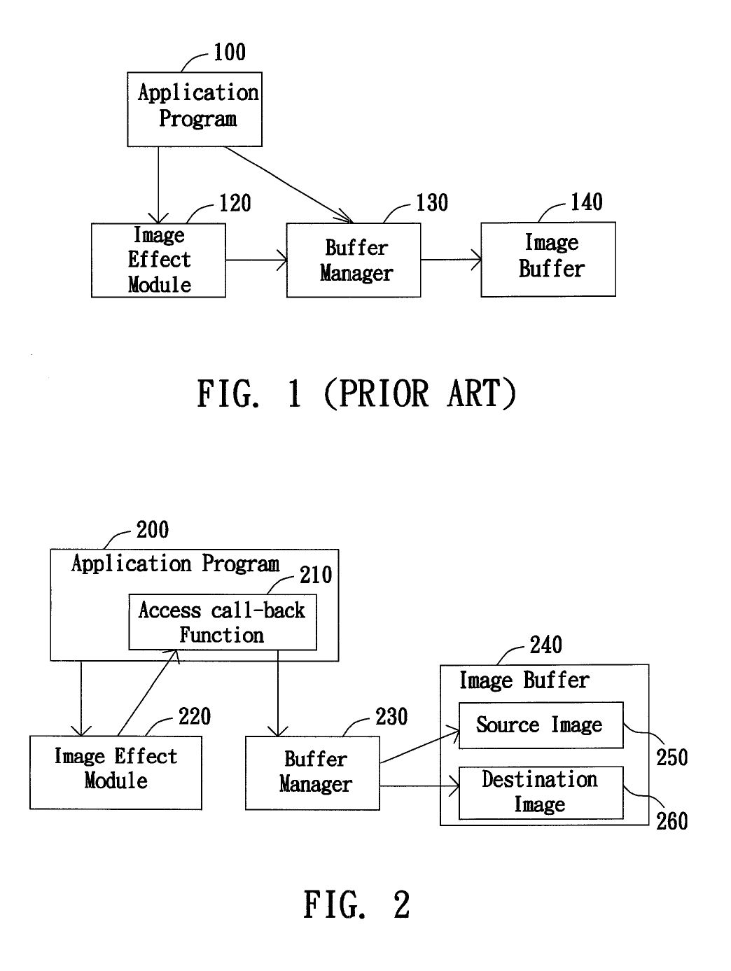

### DETAILED DESCRIPTION OF PREFERRED EMBODIMENTS

Referring to FIG. 2, the block diagram illustrates a device for producing an image effect according to a preferred embodiment of the present invention. The device for producing an image effect comprises an access call-back function unit, buffer manager, and image effect module, which is applied to an image residing in the image buffer. The device of the present invention is used to perform the image effect processing and the image accessing of the image, in which the image has a number of image pixel values. As shown in FIG. 2, the image resides in an image buffer 240 including a source image 250 and a destination image 260, wherein the image buffer 240 is a temporary memory storage for the image. The application program 200 retrieves the source image 250 and transfers both the source image 250 and the access call-back functions unit 210 to the image effect module 220. The access call-back function unit provides method 210 for accessing the image pixel values. The buffer manager 230, coupled to the access call-back function unit 210, is used for determining the access interface of the image pixel values. The image effect module 220 includes functions for performing the image effect. The image effect module 220 receives the source image 250 and the access callback function unit 210 for performing the image effect processing. In addition, the image effect module 220 performs the necessary calculations on the pixel values of the source image 250 for producing the image effect.

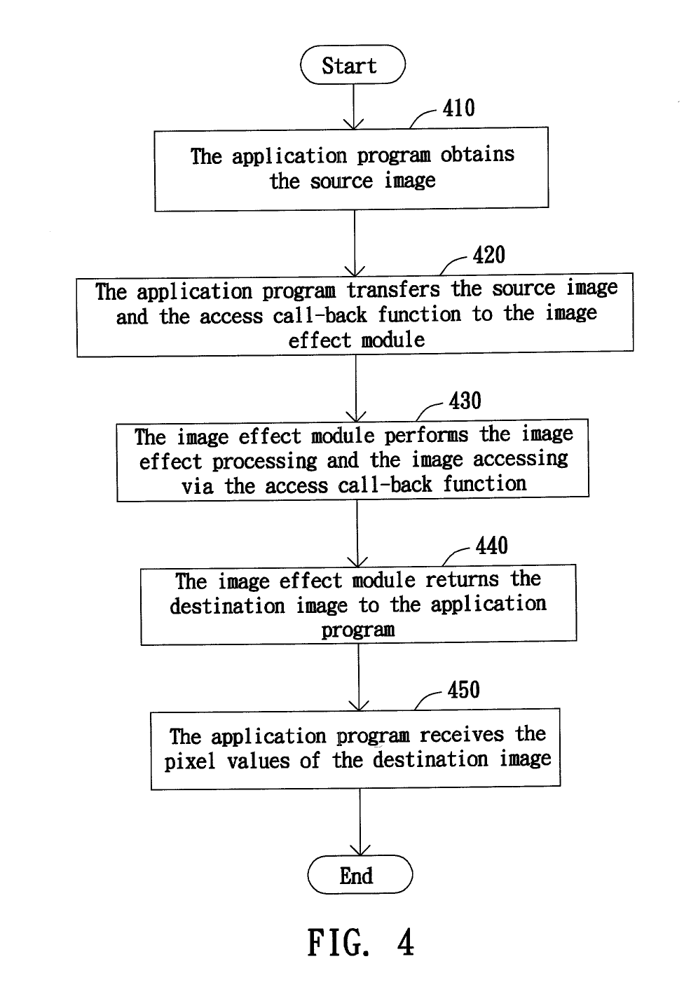

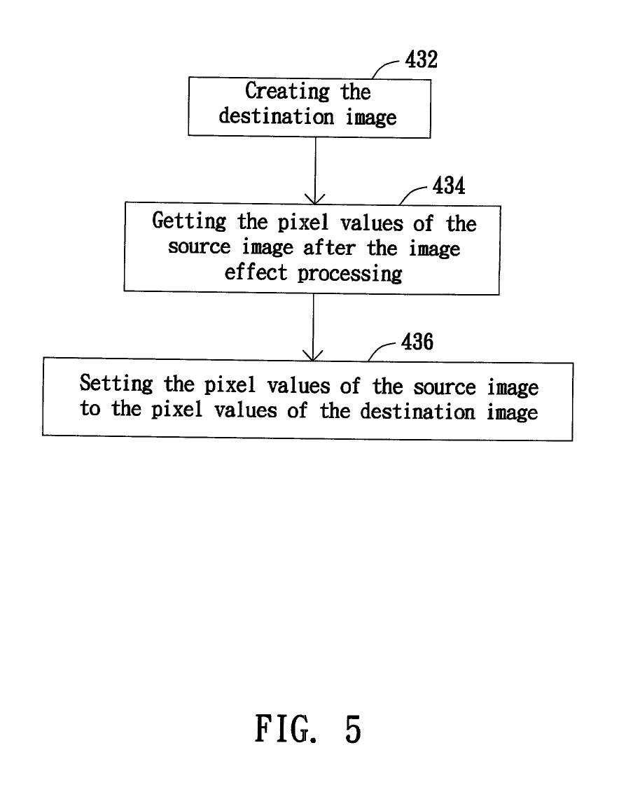

FIG. 4 is a flowchart schematically illustrating the method for producing an image effect according to a preferred embodiment of the present invention. The method for producing an image effect applying to an image that resides in an image buffer, can effectively increase the flexibility of the image effect module 220. Referring to FIGS. 2 and 4, the image resides in the image buffer 240 includes a source image 250 and a destination image 260. The method for producing an image effect starts and enters step 410. In step 410, the application 200 get the source image 250 through the buffer manager 230. In the next step 420, the application 200 calls the image effect module 220, transferring both the source image 250 and the access call-back function unit 210 to the image effect module 220 by way of parameters. After that, in the next step 430, the image effect module 220 performs the image effect processing and the image accessing via the access call-back function unit 210. The access call-back function unit 210 then collaborates with the buffer manager 230 to start the image accessing and processing. As shown in FIG. 5, a flowchart illustrates, in further detail, the procedure of image accessing using the access call-back unit.

Referring to FIG. 5, in step 432, the destination image 260 is created and resides in the image buffer 240. A number of pixel values of the source image 250 are obtained in step 434, for performing the image effect processing by the image effect module 220. The image effect module 220 performs the necessary calculations on the image pixel values. Then in step 436, the pixel values of the source image 250 are set to the pixel values of the destination image 260. An advantage of the disclosed method is that if an error occurs during the image effect processing, the image effect module 220 stops the image accessing, and the access call-back function unit 210 then can provide the capability to delete the destination image 260 and execute the step of deleting the destination image 260.

Referring to FIG. 4, when the image accessing is finished, in step 440 the image effect module 220 returns the destination image 260 to the application program 200 of FIG. 2. In step 450, the application program 200 receives the pixel values of the destination image 260 residing in the image buffer 240 through the buffer manager 230. The method for producing an image effect according to the present invention is then achieved. The destination image 260 can be displayed. According to the invention, the image effect module 220 does not directly access the image buffer 240. Instead, the image effect module 220 uses the access call-back function unit 210, which is provided by the application program 200. The access call-back function unit 210 then collaborates with the buffer manager 230 to access the image buffer 240. As a result, the device for producing an image effect in the present invention can allow any other application program having its own access call-back function unit to use the image effect module 220.

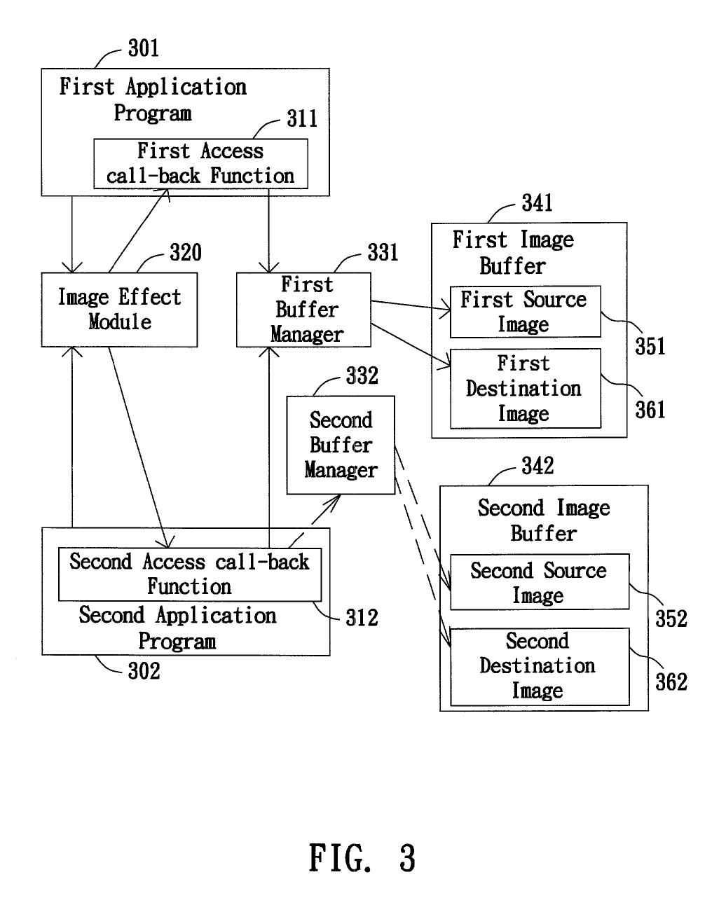

FIG. 3 is a block diagram, illustrating a device for producing an image effect, commonly shared by two different application programs, according to a preferred embodiment of the present invention. Referring to FIG. 3, both of the first application program 301 and second application program 302 can use the image effect module 320 to produce the image effect according to the aforementioned method.

As shown in FIG. 3, the first application program 301 retrieves the first source image 351 using the first access call-back function unit 311, and transfers the first source image 351 and the first access call-back function unit 311 to the image effect module 320. The image effect module 320 then performs the image effect processing and the image accessing via the collaboration of the first buffer manager 331 and the first access call-back function unit 311. After the image effect module 320 returns the first destination image 361, the first application program 301 receives the pixel values of the first destination image 361 for display. Similarly, the second application program 302 retrieves the second source image 352 using the second access call-back function unit 312, and transfers the second source image 352 and the second access call-back function unit 312 to the image effect module 320. The image effect module 320 then performs the image effect processing and the image accessing via the collaboration of the second buffer manager 332 and the second access call-back function unit 312. After the image effect module 320 returns the second destination image 362, the second application program 302 receives the pixel values of the second destination image 362 for display. The second call-back function unit 312 can produce the image effect not only by collaborating with the second buffer manager 332, but also can cope with the first buffer manager 331 by simply changing the content of the second access call-back function unit 312 to be the same as the first call-back function unit 311. In the same way, the second application program 302 can obtain the first source image 341 and receive the first destination image 361 via the first buffer manager 331 by changing the content of the first access call-back function unit 311. Therefore, it is not necessary to consider the sequence order of the image pixel values arranged in the image buffer, and thus, any buffer manager can be employed under this working model. This allows the image effect module 220 to be commonly shared by any application program, which has its own access call-back function unit without further modification to the access interface of the buffer manager. The present invention effectively increases the flexibility of the image effect module to be utilized in the application program without complicated maintenance of the image effect module. The working model of this invention helps more application to share the same image effect module.

In the foregoing description of the preferred embodiments of the present invention, a method and device for producing an image effect are disclosed, wherein the application program actively provides an access call-back function unit to perform the image accessing. The present invention offers the following advantages:

1. The image effect module can be commonly shared by many software applications that have their own access call-back function units, and therefore, it is not necessary to modify the content relevant to the access interface of the image for the image effect module to perform the image effect processing.

2. Any buffer manager can be selected to perform the image effect processing without affecting the intended image effect, and so there is no need to adopt the same buffer manager for different application programs.

3. The invention increases the flexibility of the image effect module. The application program can use the image effect module without modifications to the access interface, thereby increasing the convenience of the maintenance job of image effect module. This is very helpful for developing the image effect module or any application using it.

The present invention has been described using examples of the preferred embodiments. However, it is to be understood that the scope of the invention is not limited to the disclosed embodiments herein. On the contrast, it is intended to cover various modifications and similar arrangements. Therefore, the scope of the claims should be accorded the broadest interpretation so as to encompass all such modifications and similar arrangements.

What is claimed is:

1. A method for producing an image effect, applied to an image residing in an image buffer, wherein the image comprises a source image and a destination image, the method comprising the steps of:
(a) obtaining the source image through an access call-back function unit;
(b) transferring the source image and the access call-back function unit to an image effect module;
(c) performing the image effect processing and the image accessing through the access call-back function unit by the image effect module;
(d) returning the destination image by the image effect module; and
(e) receiving a plurality of pixel values of the destination image through the access call-back unit function.

2. The method according to claim 1, wherein said step of performing the image accessing through the access call-back function unit further comprises:
(c1) creating the destination image;
(c2) getting a plurality of pixel values of the source image after the image effect processing; and
(c3) setting the pixel values of the source image to pixel values of the destination image

3. The method according to claim 2, wherein the image accessing is stopped by the image effect module after said step (c1), the method further comprises a step of deleting the destination image by the access call-back function unit.

4. The method according to claim 2, wherein after said step of (c2), the image effect module performs a calculation to produce image effect.

5. The method according to claim 1, wherein in said step of (b), the source image and the access call-back function unit are transferred to the image effect module by way of parameters.

6. The method according to claim 5, wherein an access interface to access the pixel values of the source image and the destination image residing in an image buffer is determined by a buffer manager.

7. A device for producing an image effect, applied to an image residing in an image buffer, wherein the image has a plurality of image pixel values, the device, comprising:
an access call-back function unit, for accessing the image pixel values;
a buffer manager, coupled to the access call-back function unit, for determining the access interface of the image pixel values;
an image effect module, receiving the image and the access call-back function unit to perform the image accessing and the calculation on the image pixel values during the image effect processing.

8. The device according to claim 7, wherein the image further includes a source image and a destination image.

9. The device according to claim 8, wherein the image pixel values further include a plurality of pixel values of the source image and a plurality of the pixel values of the destination image.

10. The device according to claim 7, wherein the image effect module further includes a plurality of image effect functions.

11. The device according to claim 7, wherein the source image and the access call-back function unit are both offered to the image effect module by way of parameters.

12. The device according to claim 7, wherein when the image effect module stops the image accessing, the access call-back function unit deletes the destination image.

13. A computer readable recording medium, used to record method for producing image effects, applied to an image residing in an image buffer, wherein the image comprises a source image and a destination image, the method comprising the steps ova) obtaining the source image through an access call-back function unit;
(b) transferring the source image and the access call-back function unit to an image effect module;
(c) performing the image effect processing and the image accessing through the access call-back function unit by the image effect module;
(d) returning the destination image, by the image effect module; and
(e) receiving a plurality of pixel values of the destination image through the access call-back function unit.

14. The computer readable recording medium according to claim 13, wherein in the step of performing the image accessing through the access call-back function unit further comprises:
(c1) creating the destination image;
(c2) getting a plurality of pixel values of the source image after the image effect processing; and
(c3) setting the pixel values of the source image to be the pixel values of the destination image.

15. The computer readable recording medium according to claim 14, wherein the image accessing is stopped by the image effect module after said step (c1), the method further comprises a step of deleting the destination image by the access call-back function unit.

16. The computer readable recording medium according to claim 14, wherein after the step of (c2), the image effect module performs a calculation to produce the image effect.

17. The computer readable recording medium according to claim 13, wherein in the step of (b), the source image and the access call-back function unit are transferred to the image effect module by way of parameters.

18. The computer readable recording medium according to claim 17, wherein an access interface to access the pixel values of the source image and the destination image residing in an image buffer is determined by a buffer manager.
